(19) United States
(12) Patent Application Publication
(10) Pub. No.: US 2007/0030816 A1
(43) Pub. Date: Feb. 8, 2007

(54) DATA COMPRESSION AND ABNORMAL SITUATION DETECTION IN A WIRELESS SENSOR NETWORK

(75) Inventor: Soumitri N. Kolavennu, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/161,568

(22) Filed: Aug. 8, 2005

(51) Int. Cl. H04J 1/16; H04L 12/56

(52) U.S. Cl. 370/252; 370/401

(57) ABSTRACT

Wireless communication systems adapted for compressing data prior to certain communications. Data compression may be limited or skipped when it is determined that the data compression may cause an unacceptable amount of data to be lost. Abnormal situation detection as part of data compression is included. Methods associated with such systems are also encompassed.

### FIELD

The present invention is related to the field of wireless networks.

### BACKGROUND

Wireless communication networks can be quite useful in a variety of applications. With some wireless devices including certain sensors, a major portion of power consumption occurs when wirelessly receiving and transmitting data. Transmitting more data typically equates to using more power in such devices. Because some such devices may operate on battery power it is desirable to reduce power consumption. Further, as more devices are added, transmission bandwidth becomes an important factor in determining how large a network is feasible. Therefore, efficient use of bandwidth is also desirable.

### SUMMARY

The present invention, in a first embodiment, includes a wireless communication system adapted for compressing data prior to certain communications. Data compression may be limited or skipped when it is determined that the data compression may cause an unacceptable amount of data to be lost. Fault or abnormal situation detection in data compression is included. Methods associated with such systems are also encompassed.

### BRIEF DESCRIPTION OF THE FIGURES

FIG. 1 is a schematic diagram of a wireless sensor network;

FIG. 2 is a diagram for an illustrative embodiment;

FIG. 3 is a block diagram of a method for an illustrative embodiment;

FIG. 4 is a block diagram of a method for training steps for a gateway node;

FIG. 5 is a block diagram of a method for implementation steps for a gateway node;

FIG. 6 is a block diagram of a method for implementation steps for an infrastructure node;

FIG. 7 is a schematic diagram for another illustrative embodiment;

FIG. 8 is a schematic diagram for yet another illustrative embodiment; and

FIG. 9-12 are graphic representations of system and method testing.

### DETAILED DESCRIPTION

The following detailed description should be read with reference to the drawings. The drawings, which are not necessarily to scale, depict illustrative embodiments and are not intended to limit the scope of the invention.

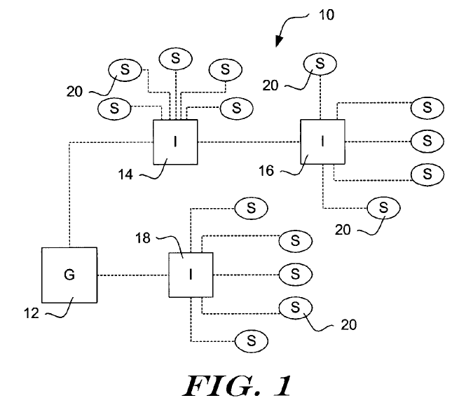

FIG. 1 is a diagram of a wireless sensor network. The network 10 includes a gateway 12, several infrastructure nodes 14, 16, 18, and a plurality of sensors 20. The infrastructure nodes 14, 16, 18 each receive data from one or more of the sensors 20 and direct the data to the gateway 12. For example, an infrastructure node 16 may receive signals from a number of sensors 20 and forward these signals to the gateway 12, either directly or, as shown in FIG. 1, via another infrastructure node 14.

The gateway 12 is shown for illustrative purposes as a form of a destination node for data gathered by the sensors 20. Other terms may be used for destination nodes such as, for example, base node or root node. Plural destination nodes may be provided in some embodiments.

In some embodiments, the infrastructure nodes 14, 16, 18 include sensors or may be characterized as sensors themselves. For example, in a “homogenous” network, the infrastructure nodes and sensors are physically identical or highly similar devices, wherein certain of the devices are located such that they may be identified as useful for serving infrastructure, as well as sensing, functions. In another example, the infrastructure nodes include the functionality of the sensors but are also adapted to further perform transmission functions. In yet another example, the infrastructure nodes are more general communication devices that lack sensing functions.

In some embodiments, the infrastructure nodes, in any of the above noted forms, may be differentiated from the sensor nodes by their power supply. For example, the sensors may be energy constrained devices (e.g. battery powered and perhaps rather inaccessible), while the infrastructure nodes may have better access to a renewable power supply (easily accessible batteries or plugged into a power supply network).

The network may also be a redundant network such as that described in copending U.S. patent application Ser. No. 10/870,295, entitled WIRELESS COMMUNICATION SYSTEM WITH CHANNEL HOPPING AND REDUNDANT CONNECTIVITY, filed Jun. 17, 2004, the disclosure of which is incorporated herein by reference.

Communication bandwidth within the system 10 may be divided in a suitable fashion to avoid data collisions. Frequency hopping, code division, scheduling and route definition may be used within the system to allow data to reach its intended destination. A relatively small network is shown in FIG. 1. As additional gateway nodes 12, infrastructure nodes 14, 16, 18 and/or sensor nodes 20 are added, data collisions may become more difficult to efficiently avoid without hampering the system responsiveness. Reducing the amount of data that is moved from node-to-node is one way of reducing the likelihood of data collisions as well as allowing for greater system responsiveness. Ultimately, provisions for data compression may increase the scalability of the system.

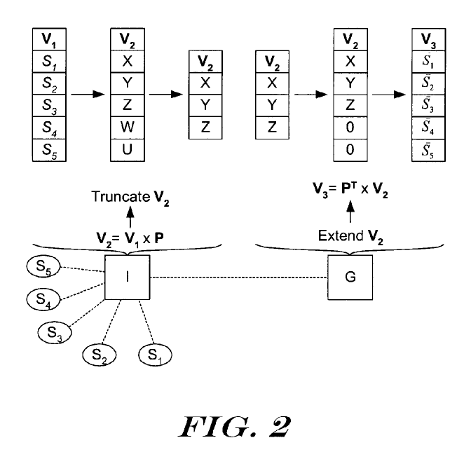

FIG. 2 is a schematic diagram for an illustrative embodiment. In the illustrative embodiment, a number of sensors S1, S2, S3, S4, S5 communicate with an infrastructure node I, which in turn sends data to a gateway G. In the illustrative embodiment, first data V₁ includes data from each of the sensors S1, S2, S3, S4, S5.

The first data V₁ is compressed by the infrastructure node I to second data V₂. Data compression is shown, illustratively, as including a matrix multiplication using a matrix P to construct second data V₂, which may then be truncated. In other embodiments, the data may be reduced in dimension during matrix multiplication as, for example, if an M-by-N matrix is the first data, and P is an N-by-X matrix, the second data V₂ is then an M-by-X matrix. In such an embodiment, if X is less than N, then the resulting data set or matrix has a reduced number of dimensions. It can be seen that, while the first data V₁ had five components or dimensions, the second data V₂ has fewer (3) components or dimensions. The reduced-dimension second data V₂ is sent by the infrastructure node I to the gateway node G.

Once the second data V₂ is received at the gateway G, it is transformed into third data V₃. In some embodiments, the gateway G may extend second data V₂ to have the same length as first data V₁, for example, by extension with zeros. Next, the second data V₂ is transformed into third data V₃ using the transpose of P, p^{T}. As indicated by the bars in the figure, the calculation results in an estimated or approximated reconstruction of the first data V₁.

In some embodiments, prior to sending second data V₂, the infrastructure node I may determine whether the truncation is sufficiently accurate to approximate first data V₁ when reconstructed at the destination/gateway node. The truncated elements may be compared to one or more thresholds. In another embodiment, the infrastructure node I may construct third data V₃ to determine a level of inaccuracy introduced by the truncation. If the error introduced by truncation exceeds a predetermined level, the infrastructure node I may send first data V₁, rather than second data V₂, to the gateway node. In some embodiments, a finding that the distortion/error falls outside a set of parameters may be considered as indicating an abnormal situation, which may be treated as a fault as well. The occurrence of abnormal situations may be counted or otherwise considered, for example, to determine whether reconfiguration of the system and/or the transform matrix P, is indicated.

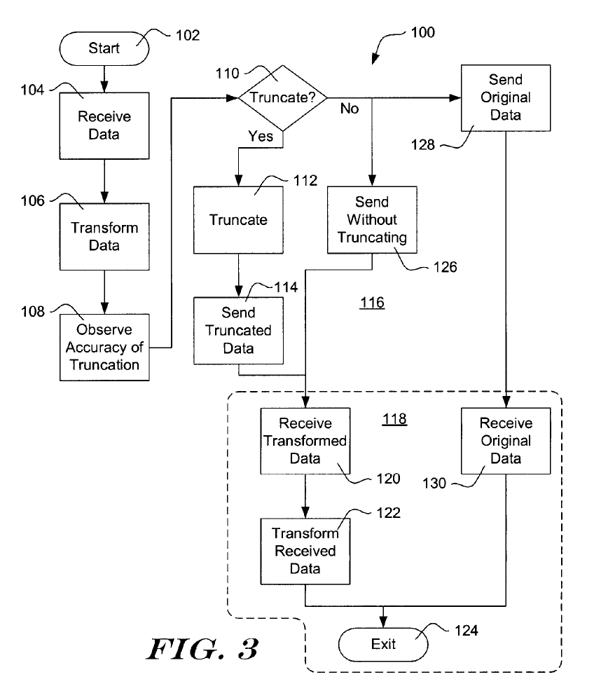

FIG. 3 is a block diagram of an illustrative method in accordance with the present invention. The illustrative method 100 includes a first portion 116 that is performed by an infrastructure node, and a second portion 118 that is performed at a gateway node. From a start block 102, the infrastructure node receives data, as shown at 104, from one or more sensor nodes. The data is then transformed as shown at 106, which may include modifying matrix axes for a number of data points or elements. Next, the accuracy of a proposed truncation is checked, as shown at 108. A decision is then made, as shown at 110, whether to truncate the resulting data.

If the decision at 110 is a yes, the data is truncated, as shown at 112. The truncated data may then be sent to the gateway node, as shown at 114. The sent data is received by the gateway node, as shown at 120, and converted as shown at 122. The method ends as shown at 124 once these steps are complete.

Returning to step 110, there are two alternatives for sending data if it is not to be truncated. First, the transformed data may be sent without truncating, as shown at 126. This data, when received by the gateway node at step 120, would then be transformed again at step 122. Alternatively, the original data may be sent, as shown at 128. This original data can be received by the gateway node, as shown at 130. Since conversion is not needed, the method then ends at 124.

In some embodiments, the gateway node may identify whether conversion of the data or other reconstruction is needed by observing the sent data. In some embodiments, the length of the sent data is used to determine whether the data has been truncated and therefore needs reconstruction. For such embodiments, a flag or counter may be used by the gateway node to make note of data conversion errors, which may indicate that a new conversion process is needed. In other embodiments, the sent data may include a flag or marker to indicate its format.

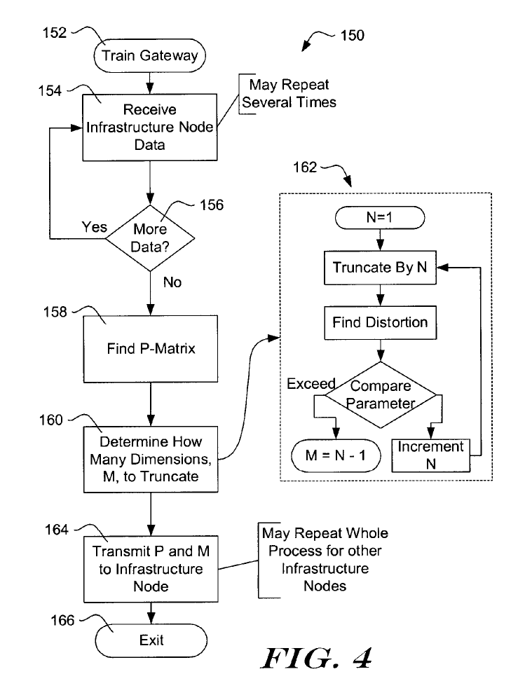

FIG. 4 is a block diagram of a method for training steps for a gateway node. The method 150 is indicated at 152 as being intended as the steps a gateway node follows during a system training process. The gateway receives data from an infrastructure node, as shown at 154. As noted, steps 154, 156 may be repeated several times until a desired size data set is gathered. If desired, one or more data elements may be excluded from the training data set if such samples are determined to be outliers. With sufficient data, a P-matrix may be found as shown at 158, for example using principal components analysis by any suitable technique for finding the principal components of a data set.

Next, as shown at 160, it is determined how many dimensions, M, of the captured data to truncate. Step 160 may include, for example, the submethod shown at 162. A value N is set initially to 1. The data points in the gathered data set are converted using the matrix P, and truncated by N dimensions. Next, the distortion that results from the truncation is found, and the distortion is compared to a parameter for training distortion, which may be, in some embodiments, more strict than the parameter used in implementation of the data compression.

In other embodiments, the training distortion parameter is the same as the distortion parameter used in implementation. If there is enough distortion caused by the truncation that the training distortion parameter is violated, then M is set to N−1, the last value for which truncation did not cause violation of the training distortion parameter. The distortion may be found and analyzed on a point-by-point basis through the set of data points, or may be analyzed on a broader scale across the set of data points, or both. The standard deviation/variance of distortion may be calculated as well. If the training distortion parameter is not exceeded, the submethod 162 increments N and again performs the distortion analysis.

Distortion may be found in any suitable manner. For example, in steps 158 and 160, assuming that the original data includes a number of 6-dimensional vectors, the original principal component matrix P will be a 6-by-6 matrix. For a sample vector A, the cross product of A X P will yield another 6-dimensional vector B. Due to the nature of principal components analysis, much of the vector information (assuming a cross-correlated set of sample vectors) in B will be contained in the first few dimensions, such that truncation of the 6^{th} and/or 5^{th} elements of B results in a low loss of data. The amount of distortion introduced may be examined, for example, by observing how much each vector is modified using the following formula:

$$Error = \frac{1}{j} * {\sum }_{j} \vert {A}_{ i} - { {A}^{ \_}}_{ i} \vert / \vert {A}_{ i} \vert$$

Where j is the number of samples in the original data, Aᵢ-bar is the reconstruction of Aᵢ from a truncated vector Bᵢ. The error in the formula is thus in the form of a percentage calculated using the initial vector magnitudes. For example, an error of 5% or 10% may be considered acceptable, depending upon the application. Various other methods of calculating distortion or error, as well as thresholds for acceptable distortion, may be used, as desired.

Once the number of dimensions to eliminate, M, is calculated, the method continues by transmitting the transform matrix P and the number of dimensions to truncate, M, to the infrastructure node, as shown at 162. Alternatively, the number of dimensions that are to be retained may be transmitted. The method may be repeated for other infrastructure nodes. The gateway training method ends as shown at 164.

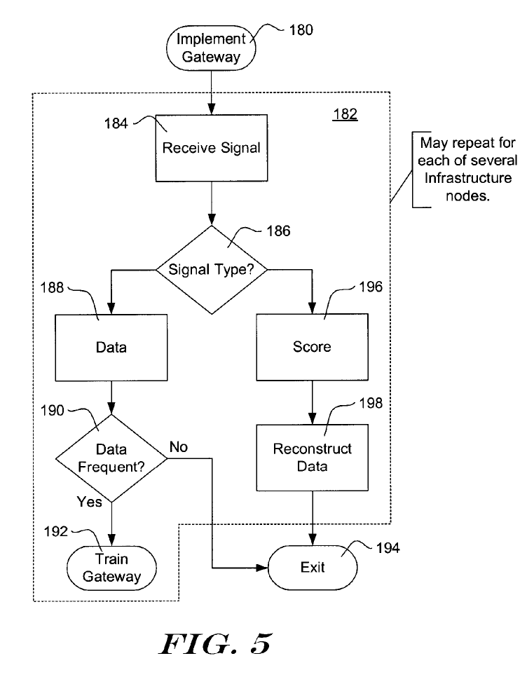

FIG. 5 is a block diagram of an illustrative method for implementation steps for a gateway node. FIG. 5 makes reference to the term “score”. With respect to principal components analysis, a “score” refers to a value in the matrix S resulting from the following mathematical expression:
Sₙₓₚ=PₙₓₙXₙₓₚ

Where P is the transformation matrix and X is one of the original multi-dimensional data points. The matrix X may be referred to as first data. If data compression occurs, then S will be truncated and the truncated matrix S may be referred to as second data generated from the first data having fewer dimensions than the first data.

Turning to FIG. 5, the illustrative gateway implementation begins at 180, and includes a process 182 that may be repeated for each of several infrastructure nodes. A signal is received from the infrastructure node, as shown at 184. The gateway then determines what type of signal was received, as shown at 186. If a data signal is received, as shown at 188, it may indicate that data compression has not been used, and so it is then determined whether data has been received frequently, as shown at 190. For example, if data is received, rather than a score corresponding to data compression, for at least X out of Y most recent signals, the data may be considered “frequent,” and the method goes on to train the gateway, as shown at 192. Actual values for X and Y may vary, one illustrative example uses 10/25 as an X/Y ratio for determining if the data is frequent and re-training is indicated. If data is not frequent at 190, the method ends, as shown at 194.

If scores are received, as shown at 196, this means that the infrastructure node has sent compressed data. An approximation of the original data is then reconstructed as shown at 198, and the gateway implementation may then exit at 194. Alternatively, the process 182 may be repeated for a next infrastructure node.

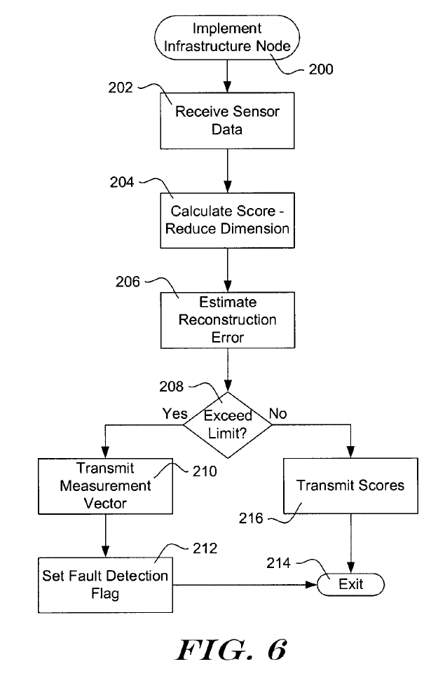

FIG. 6 is a block diagram of an illustrative method for implementation steps for an infrastructure node. The method starts at 200 and includes receiving sensor data, as shown at 202. The sensor data may be received from a plurality of sensors of similar, same, or different types. A score is then calculated corresponding to a reduced dimension representation of the sensor data, as shown at 204. Next, a reconstruction error is estimated, as shown at 206. Next is a decision of whether the reconstruction error exceeds a limit, as shown at 208. If the error exceeds the limit at 208, the actual measurement vector is transmitted, as shown at 210, and a fault detection flag may be set, or a fault detection counter may be incremented, to indicate that a data compression fault has occurred, as shown at 212. The fault may indicate an abnormal situation at a sensor or within a group of sensors, for example. The method ends as shown at 214. If the error does not exceed the limit at 208, the scores/reduced vector set is transmitted, as shown at 216. As discussed herein, depending upon which of several illustrative examples is in operation, fault detection may occur to indicate that parameters for data compression may be in error, or abnormal situations may be detected to indicate that there is an abnormal situation occurring at an observed/sensed location.

While the above examples indicate that the gateway performs the data manipulations used in configuring the data compression, this need not necessarily be the case. For example, one of the infrastructure node or sensor node may perform the analysis to generate vector conversion factors by principal component analysis. Parameters for conversion/compression of the data may then be transmitted to the appropriate node(s) for re-conversion of the data.

In the above example, the sensors are shown at single dimension sensors, though this need not be the case. An example of a system having single dimension sensors may be an array of temperature sensors. In some embodiments, rather than a single dimensional sensor, individual sensors may generate multiple dimensions of data. For example, a sensor may sense both temperature and pressure within a boiler, where temperature and pressure are often well correlated except in circumstances where an abnormal situation is occurring in a boiler. In another example, a sensor for observing burner operation may include a number of optical detection elements that may also correlate well except when an abnormal situation is occurring in the burner. A sensor may also sense data at a number of points in time to create multi-dimensional data. The above embodiments also show, for purposes of simplicity in illustration, 1-by-N matrices. In other embodiments M-by-N matrices may also be data elements that are treated as data points in the manner discussed above.

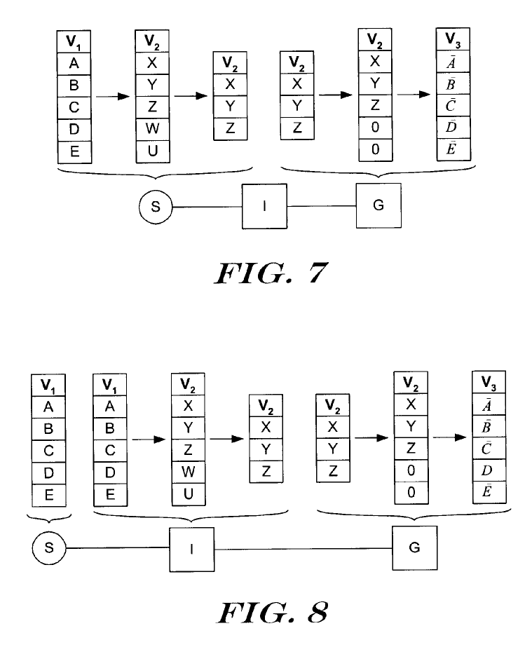

FIG. 7 is a diagram of another illustrative embodiment of the present invention. In the illustrative embodiment, a sensor S communicates with an infrastructure node I, which in turn sends data to a gateway G. The sensor captures multi-dimensional data in first data V₁. The sensor S converts first data V₁ into second data V₂, for example with the use of principal components. The sensor S can then truncate second data V₂, and transmit the truncated, converted second data to the infrastructure node I, which in turn sends the second data to the gateway G, where an approximation, third data V₃, of first data V₁ is reconstructed. The overall system may work in an analogous manner to the above embodiments, including, for example, training that can be performed at any of the sensor, infractructure, or gateway node. The sensor S may, for example, determine whether or not truncation will result in an error/distortion that falls outside of a predetermined threshold.

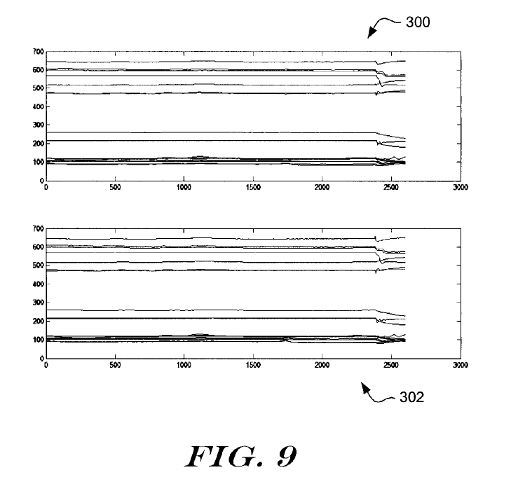

FIG. 8 is a diagram of yet another illustrative embodiment of the present invention. In this illustrative embodiment, a multi-dimensional sensor S generates a first data V₁ that is transmitted to an infrastructure node I. At the infrastructure node I, first data V₁ is converted to second data V₂, which may then be truncated if appropriate in a manner analogous to that discussed above. The second data V₂ is sent to the gateway node G, extended, and converted to an approximation, third data V₃, of first data V₁. More than one sensor S may send multi-dimensional data to the infrastructure node I such that first data V₁ is an M-by-N matrix, rather than just a vector as shown.

In illustrative embodiments of the present invention, a further advantage of using transformed and, often, reduced dimension data in transmissions is that it creates a layer of security or encryption. Specifically, without knowing the transform matrix or vector, as well as how many dimensions are being removed, a listener would receive gibberish. With reduced dimensions however, the effect is not that of traditional encryption where the actual data can be reconstructed. Instead, with illustrative embodiments of the present invention data resembling the actual data may be reconstructed.

Also in illustrative embodiments, the present invention allows simple and quick detection of abnormal situations. When the actual data, rather than transformed and reduced dimension data, is transmitted, this may indicate a fault in the underlying system and/or an abnormal situation in a sensed condition. An example may be an illustrative embodiment of the present invention that may be used to monitor temperatures in a power plant reactor. If the distortion parameters are exceeded by conditions sensed in a portion of the reactor, this would indicate that the temperatures in that portion of the reactor are falling outside of a “normal” range used to generate the initial transformation.

When actual or raw data is transmitted, rather than transformed and reduced data, the system may note that an abnormal situation is occurring and enter into a fault detection, prevention, or amelioration mode that may detect emergency conditions. The fault mode may call for steps such as annunciating the faults to another resource such as a systems or emergency management resource, or simply raising an alarm. Instead of occasionally modifying the transform parameters, such a fault detection system may set parameters for indicating normal operation and abnormal operation. When abnormal operation is detected, the parameters would remain the same. Because the sensors or infrastructure nodes generating the out-of-range data are readily identified, the location of the possible problem in the reactor can be readily identified.

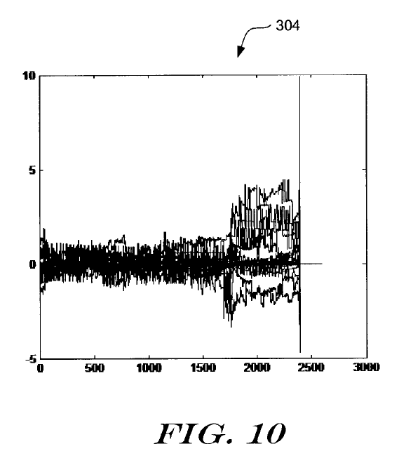

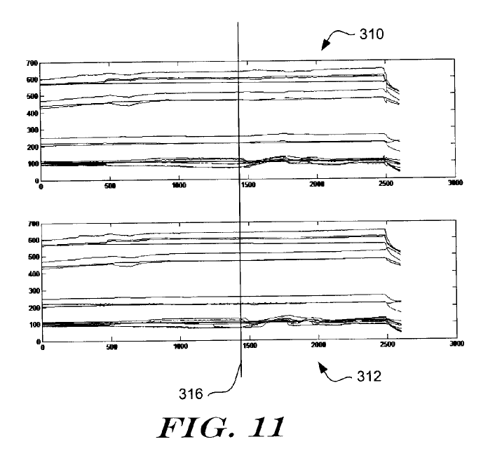

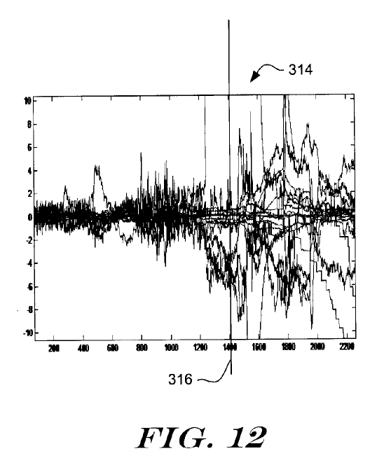

FIG. 9-12 are graphic representations of system and method testing. Data for FIGS. 9-12 originates in a fuel processor reactor for a fuel cell plant. Data from 20 temperature sensors was gathered. Training, including the construction of a principal component analysis model, was performed on data collected over the course of two hours at five second intervals. After the training phase, the model was used to calculate scores of the first five principal components, and only these scores over the five components were transmitted for the next two hours, again at five second intervals. FIGS. 9-10 correspond to a first four hour session, and FIGS. 11-12 correspond to a second four hour session.

Referring now to FIG. 9, the reconstructed data is shown in the upper graph at 300, and is generally quite consistent with the actual data shown at 302. FIG. 10 illustrates the percentage error of the reconstructed data points for each of the twenty sensors in chart 304. It can be seen that the error percentages are well below ten percent for most of the time period shown, though a portion of the error data indicates that the reduced data set introduced error in excess of ten percent for certain data points. During this time period, an abnormal situation may be detected, as discussed in the illustrative embodiments above. However, for most of the time period shown, the method of data dimension reduction used was able to reduce a set of 20 data points to 5 without significant data loss.

Referring now to FIG. 11, again, the reconstruction is shown in graph 310, and the actual data is shown at 312. The actual data representations appear rather well correlated. The percent error of reconstruction is shown in the graph 314 in FIG. 12. Line 316 is shown for reference purposes in each of FIGS. 11 and 12, to show a point in time. Prior to this point in time, the error levels remain quite low, below about 5%. It can be seen that an event occurred in the actual temperature data in graph 312, and that the error in reconstruction increases significantly after this point in time. Thus, reconfiguration may be indicated to reduce the later occurring errors.

The estimated power reduction in the testing shown by FIGS. 9-12 is about 47%, and it can be seen that the temperature data is preserved.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A wireless communication system comprising a destination node and one or more sensors, wherein:
the sensors gather first data having first dimensions;
second data is generated from the first data, the second data having second dimensions less than the first dimensions;
if the second data is an approximation of the first data within a set of distortion parameters, the second data is transmitted to the destination node;
else the second data is not transmitted to the destination node.

2. The system of claim 1 wherein, if the second data is not an approximation of the first data within a set of distortion parameters, the first data is transmitted to the destination node.

3. The system of claim 1 further comprising infrastructure nodes wherein each sensor generates single dimension data points that are gathered at the infrastructure nodes as the first data.

4. The system of claim 1 wherein certain of the sensors are infrastructure nodes as well, and the infrastructure nodes are used to gather the first data from other sensors and route the second data to the destination node.

5. The system of claim 1 wherein principal components analysis is used to generate a conversion matrix for the first data, and truncation is used to reduce the number of dimensions of the second data.

6. The system of claim 1 wherein each sensor generates multi-dimensional data.

7. The system of claim 6 wherein a sensor gathers the first data, generates the second data from the first data, and determines whether the second data is an approximation of the first data within the set of distortion parameters.

8. The system of claim 1 wherein the system engages in a training mode including the steps of:
gathering a plurality of multi-dimensional data points in the same manner as the first data is gathered, each multi-dimensional data point having parameters in common with the first data;
performing principal components analysis on the plurality of multi-dimensional data points to construct a principal components matrix for transforming the multi-dimensional data points; and
identifying one or more dimensions for truncation of data using the principal components matrix and the distortion parameters.

9. A method of operation within a wireless communication network, the wireless communication network including at least one destination node and one or more sensors, the method comprising:
performing a data transfer function including the following steps:
capturing first data using the sensors, the first data having a number of dimensions;
transforming the first data into second data having a reduced number of dimensions; and
determining whether the second data approximates the first data within a distortion parameter, and:
if so, transmitting the second data with addressing instructions for reaching the destination node.

10. The method of claim 9 wherein the network further includes at least one infrastructure node, wherein an infrastructure node receives data from a plurality of the sensors to construct the first data, and performs the steps of transforming, determining and transmitting.

11. The method of claim 9 wherein the sensors are multi-dimensional sensors and the sensors perform the steps of transforming and determining.

12. The method of claim 9, wherein, if the second data does not approximate the first data within a distortion parameter, the first data is transmitted to the destination node.

13. The method of claim 12 further comprising:
if the second data is transmitted, receiving the second data at the destination node; or
if the first data is transmitted, receiving the first data at the destination node, noting that the first data was received, and determining whether reconfiguration is needed to modify how the transforming step is performed.

14. The method of claim 13 wherein the step of determining whether reconfiguration is needed includes observing how often first data, rather than second data, is received.

15. The method of claim 13 wherein the transforming step includes using a transformation matrix related to a principal components analysis of data previously captured by the sensors, and if it is determined that reconfiguration is needed, the method includes reconfiguring by recalculating the transformation matrix.

16. The method of claim 9 wherein, if the second data does not approximate the first data within a distortion parameter, an abnormal situation is indicated to the destination node.

17. The method of claim 16 wherein, if an abnormal situation is indicated to the destination node, the destination node determines where the abnormal situation occurred.

18. The method of claim 9 wherein the transforming step includes reducing the number of dimensions by a number M, the method further comprising performing a training function including the following steps:
accumulating a training set including number of multi-dimensional data points related to data captured by the sensors;
analyzing the training set to construct a principal components matrix;
transforming the training set into a principal components set; and
starting with N=1, performing the following steps:
truncating elements of the training set by a number of dimensions, N;
determining whether the truncated elements approximate corresponding multi-dimensional data points to within a training parameter; and
if so, increasing N and going back to the truncating step; or
if not, setting M equal to N−1.

19. A wireless communication system comprising a destination node, one or more infrastructure nodes, and a number of sensors, wherein:
an infrastructure node receives first data from the sensors, the first data having a first set of dimensions;
the infrastructure node generates second data from the first data, the second data having a second set of dimensions, the second set of dimensions being reduced from the first set of dimensions;
the infrastructure node determines whether the second data provides an approximation of the first data within a set of parameters; and:
if so, the infrastructure node directs the second data to the destination node.

20. The system of claim 19 wherein, if the second data does not provide an approximation of the first data within a set of parameters, the infrastructure node directs the first data to the destination node.

21. The system of claim 20 wherein, if reconfiguration is indicated:
the destination node receives a training set comprising multi-dimensional data points captured from the sensors;
a transformation matrix is generated using principal components analysis of the training set;
a dimension reducer is generated using the training set, the transformation matrix, and a parameter for training distortion, the dimension reducer indicating how many dimensions of data may be truncated during the step of generating the second data from the first data; and
the transform matrix and dimension reducer are communicated to the infrastructure node for use in the step of generating the second data from the first data.
